(19) United States
(12) Patent Application Publication
(10) Pub. No.: US 2005/0058312 A1
(43) Pub. Date: Mar. 17, 2005

(54) Hearing aid and method for the operation thereof for setting different directional characteristics of the microphone system

(76) Inventor: Tom Weidner, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/900,509

(22) Filed: Jul. 28, 2004

(30) Foreign Application Priority Data
Jul. 28, 2003 (DE) 103 34 396.2

(51) Int. Cl. H04R 25/00

(52) U.S. Cl. 381/313; 381/316

(57) ABSTRACT

To improve the signal transmission behavior in a hearing aid with a directional microphone system having at least three microphones, a number of those microphones are connected to form microphone units, the order of the directional characteristic of these microphone units being matched in each case. The microphone signals of these microphone units are added so that the order of the directional characteristic of the resulting microphone system also corresponds to the order of the directional characteristic of the individual microphone units. As a result, the signal transmission behavior is improved in comparison to an individual microphone unit, without causing increased microphone noise or worsening of the sound quality.

### BACKGROUND OF THE INVENTION

1. Field of the Invention

The present invention relates to a hearing aid and to a method for operating a hearing aid with at least three microphones that can be electrically connected to one another in order to form a directional microphone system.

2. Description of the Prior Art

Arrangements for classifying hearing situations are used in modern hearing aids. The transmission parameters of the hearing aid are varied automatically in accordance with the current hearing situation. The classification may influence, inter alia, the method of operation of interference suppression algorithms, as well as influencing the microphone system. For example, depending on the hearing situation that is detected, a selection is made (discrete switching or continuous fading) between an omnidirectional characteristic (directional characteristic of the zero order) and a significant directional effect of the microphone system (directional characteristic of the first order or of a higher order). In order to generate the directional characteristic, gradient (inherently directional) microphones are used or a number of omnidirectional microphones are electrically connected to one another. Such microphone systems exhibit a frequency-dependent transmission behavior in which a significant drop at low frequencies is experienced. In contrast, the noise behavior of the microphones is independent of frequency and is slightly amplified in comparison with an omnidirectional microphone. In order to obtain a natural sound impression, the high pass frequency response of the microphone system must be compensated by amplifying the low frequencies. The noise that is present in the low frequency range also is amplified and may under certain circumstances become distinctly and disruptively audible, while soft sounds are hidden by the noise.

PCT Application WO 00/76268 discloses a hearing aid with a signal-processing unit and at least two microphones that can be connected to one another to form directional microphone systems of different orders, the directional microphone systems themselves being capable of being connected to one another with a weighting which is dependent on the frequency of the microphone signals which are output by the microphones. Depending on the result of the signal analysis, the limiting frequency can be set between adjacent frequency bands in which different weighting of the microphone signals is provided.

European Application 0 942 627 discloses a hearing aid with a directional microphone system with a signal processing device, one earpiece and a number of microphones the output signals of which can be connected to one another with different weighting in order to generate an individual directional microphone characteristic by means of delay devices and the signal processing device. In the directional microphone system, the preferred reception direction (main direction) can be set individually according to a current hearing situation.

U.S. Pat. No. 5,524,056 discloses a hearing aid with an omnidirectional microphone and a directional microphone of the first order or of a higher order. The microphone signal of the directional microphone is amplified in the range of low signal frequencies and approximated to the microphone signal of the omnidirectional microphone. Both the microphone signal of the omnidirectional microphone and the microphone signal of the directional microphone are fed to a switching unit. In the first switching state of the switching unit, the omnidirectional microphone is connected to a hearing aid amplifier, and in a second switching state of the switching unit the directional microphone is connected to a hearing aid amplifier. The switching unit can switch automatically as a function of the signal level of a microphone signal.

A disadvantage with known hearing aids with a directional microphone system is that in certain hearing situations either the directional effect of the microphone system is not used to an optimum degree, or a high degree of directional effect leads to a significantly audible worsening of the sound quality.

### SUMMARY OF THE INVENTION

An object of the present invention is to improve the sound quality of a hearing aid with a directional microphone system.

This object is achieved in accordance with the invention by a hearing aid with at least three microphones that are electrically connected to one another to form a directional microphone system, wherein at least two of the microphones are connected to form a first microphone unit with a directional characteristic of a specific order, and wherein at least two of the microphones are connected to form a second microphone unit with a directional characteristic of the same order, and wherein the two microphone units are connected to form a third microphone unit with a directional characteristic of the same order.

The above object also is achieved in accordance with the invention by a method for operating a hearing aid with at least three microphones that are electrically connected to one another to form a directional microphone system including the steps of electrically connecting at least two of the microphones to form a first microphone unit with a directional characteristic of a specific order, and electrically connecting at least two of the microphones to form a second microphone unit with a directional characteristic of the same order, and electrically connecting the two microphone units to one another to form a third microphone unit with a directional characteristic of the same order.

The hearing aid according to the invention has a microphone system with at least three microphones so as to be able to implement directional characteristics from the zero order to the second order. It is also possible to provide, however, more than three microphones so that directional characteristics of a higher order are also possible. Furthermore, the hearing aid has a signal-processing unit for processing the microphone signal that is generated by the microphone system, and for amplifying it as a function of frequency. The emission of audio signals usually is carried out by an earpiece that produces an acoustic output signal. Other output transducers, for example ones that generate vibrations transmittable via bores, are also known.

As used herein directional characteristic of the zero order means an omnidirectional characteristic that starts, for example, from an individual omnidirectional microphone that is not connected to other microphones. A microphone unit with a directional characteristic of the first order (directional microphone of the first order) can be implemented, for example, by means of a single gradient microphone or by electrically connecting two omnidirectional microphones. With directional microphones of the first order it is theoretically possible to achieve a maximum value of the directivity index (DI) of 6 dB (hypercardioid). In practice, given optimum positioning of the microphones and the best tuning of the signals that are generated by the microphones, DI values of 4 to 4.5 dB are obtained on a KEMAR (a standard research dummy). Directional microphones of the second order and of a higher order have DI values of 6 dB and more, which are advantageous, for example, for better comprehension of speech. If the hearing aid contains a microphone system with, for example, three omnidirectional microphones, it is possible on this basis to realize microphone units with directional characteristics of the zero order to the second order simultaneously by suitable connection of the microphones.

An individual omnidirectional microphone constitutes in and of itself a microphone unit of the zero order. If, when there are two omnidirectional microphones, the microphone signal of one microphone is delayed and subtracted from the microphone signal of the other microphone, a microphone unit of the first order Is produced. If, in turn, when there are two microphone units of the first order, the microphone signal of one microphone unit is delayed and subtracted from the microphone signal of the other microphone unit of the first order, a microphone unit with a directional characteristic of the second order is produced. In this way, it is possible to realize microphone units of any desired order depending on the number of omnidirectional microphones.

If a microphone system includes microphone units of a different order, it is possible to switch between different directional characteristics, for example by switching one or more microphones on or off. Furthermore, by means of a suitable electrical connection of the microphone units it is also possible to produce any desired combination of the directional characteristics of different orders, For this purpose, the microphone signals of the microphone units are weighted differently and added before they are processed further and amplified in the signal-processing unit of the hearing aid. As a result, it is also possible to implement a continuous gradual transition between different directional characteristics, allowing disruptive artifacts to be avoided during switching.

The underlying concept of the invention is that, in a directional microphone system with a number of microphones, it is not the largest possible order of the directional effect with the given number of microphones that should be set, but instead a number of microphone units are formed with a lower order than the largest possible order and the microphone signals produced by these microphone units are provided for further processing. In this context, the different microphone units can be optimized for specific frequency ranges so that, after the combination of the microphone signals that are provided by the microphone units with directional characteristics of the same order, a directional microphone of the same order is produced. This directional microphone exhibits an improved signal transmission behavior in comparison to the individual microphone units over a wide frequency range or over the entire frequency range to be transmitted.

A different frequency response of the microphone units can be formed, for example, by means of a suitable selection of the omnidirectional microphones that are electrically connected to one another to form the microphone unit. As a result, for example for a first microphone unit, it is possible to select two omnidirectional microphones that are at a relatively short distance from one another (i.e., the incoming signal ports are at such a spacing), so that it is not the distance between the microphones themselves that is decisive for the directional effect, but rather the distance between the sound inlet openings of these microphones. Generally, however, identical microphones are used in hearing aids with a directional microphone system, and the mounting of the microphones and the connections of these microphones to, in each case, one sound inlet opening in the housing of the hearing aid are carried out essentially in the same way for all microphones, so the distance between the microphones corresponds to the distance between the sound inlet openings of these microphones. If this is not the case, as used herein the term “distance between two microphones” means the distance between the sound inlet openings in the housing of the hearing aid, these openings being each connected to a microphone via an acoustic duct (tube).

In a second microphone unit, two omnidirectional microphones are connected to one another and the distance between the two omnidirectional microphones is relatively large in comparison with the distance from the first microphone unit Because the signal transmission behavior of a directional microphone that is composed of two omnidirectional microphones depends on the distance between the microphones, the two microphone units that are formed in this way differ in their signal transmission behavior although both microphone units have the same order of directional characteristic (the first order in the example). In particular, the microphone unit with the shorter distance between the two omnidirectional microphones is more suitable for transmitting high frequencies, and the microphone unit with the larger distance between the two omnidirectional microphones employed is more suitable for transmitting low frequencies. If the microphone signals that are produced by the two microphone units are then combined, a microphone system that exhibits a good signal transmission behavior over a wide frequency range is obtained. Furthermore, in the microphone system formed in this way, the signal-to-noise ratio is improved in comparison to a directional microphone in which the largest possible order of the directional effect with the existing number of microphones is set.

As well as connecting microphones at different distances, there is a further possible way of forming microphone units with a directional characteristic of the same order and a different signal transmission behavior. By setting the signal delay for at least one microphone signal of the microphones that are connected to one another to form a microphone unit, it is possible to set an “artificial distance” between these microphones. In this case, increasing the signal delay in fact also contributes to an improvement in the signal transmission behavior in the low frequency range and to a worsening at relatively high frequencies, similarly to the situation where the physical distance between the microphones is increased. By setting different delay times with a number of microphone units it is thus possible to achieve an improvement in the overall resulting signal transmission behavior even if the individual microphones of the different microphones units are each arranged at the same distance from one another.

The invention provides significant advantages for wearers of hearing aids, For example, the microphone system generates less noise than a microphone system with the highest order of the directional characteristic that is possible with the existing number of microphones. Furthermore, the microphone system has a high degree of sensitivity over a wide frequency range. The existing high pass effect that is typical with directional microphones, and that leads to falsification of the customary acoustic pattern, thus can be reduced. Furthermore, the directional effect is also Improved. For example, the AI-DI of a directional microphone system constructed according to the invention is higher than for a conventional directional microphone system of the same order.

In an embodiment of the invention a weighting unit is connected downstream of the different microphone units and differently weights the microphone signals produced by the different microphone units, before the addition.

The hearing aid according to the invention can be, for example, a behind-the-ear hearing aid, an in-the-ear hearing aid, an implantable haring aid, a pocket hearing aid or a spectacles-mounted hearing aid. Furthermore, the hearing aid according to the invention may be part of a hearing aid system including several devices for the hearing impaired, for example part of a hearing aid system with two hearing aids worn on the head for binaural supply, part of a hearing aid system with a hearing aid worn on the head with an external processing unit carried on the body, part of a hearing aid system implanted entirely or partially and having a number of components, or part of a hearing aid system with external additional components such as a remote control unit or external microphone unit.

### DESCRIPTION OF THE DRAWINGS

FIG. 1 shows a hearing aid that can be worn behind the ear having three microphones, which can be connected according to the invention.

FIG. 2 is a simplified block circuit diagram of a directional microphone system of a hearing aid with three omnidirectional microphones, in accordance with the invention.

FIG. 3 is a simplified block circuit diagram of an alternative embodiment of a directional microphone system of a hearing aid with three omnidirectional microphones in accordance with the invention.

FIG. 4 shows the signal transmission behavior of a directional microphone system constructed from three microphones according to the invention.

### DESCRIPTION OF THE PREFERRED EMBODIMENTS

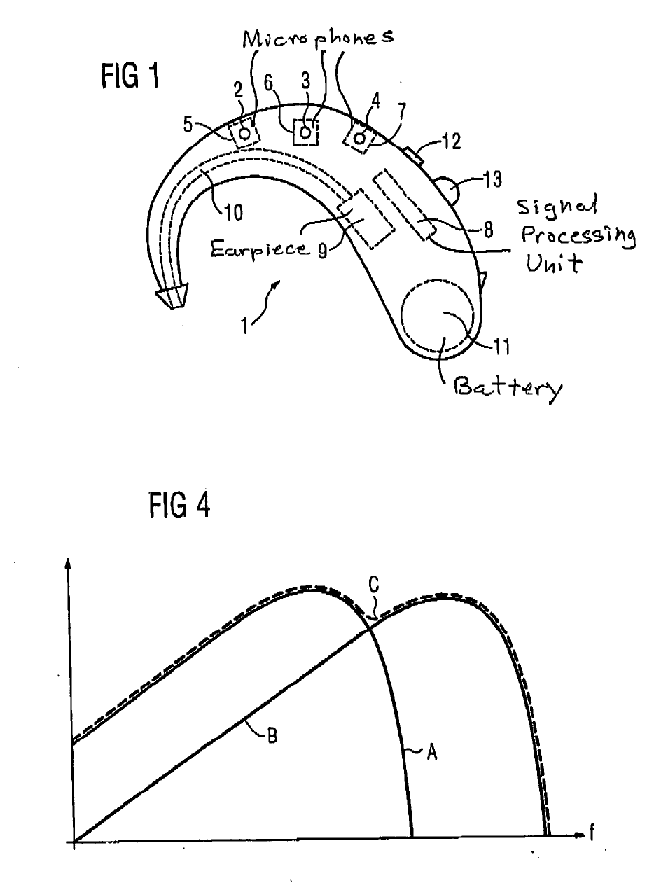

FIG. 1 shows a behind-the-ear hearing aid 1 having a housing with three sound inlet openings 2, 3 and 4. The sound passing into the sound inlet opening 2 is fed to an omnidirectional microphone 5, the sound passing into the sound inlet opening 3 is fed to an omnidirectional microphone 6, and the sound passing into the sound inlet opening 4 is fed to an omnidirectional microphone 7. The microphones 5 to 7 each convert an acoustic Input signal into an electrical microphone signal, it being possible to set different directional characteristics of the microphone system by means of different electrical connections of the microphones 5, 6 and 7. The microphone signal produced by the microphone system is fed to a signal-processing unit 8 for further processing and frequency-dependent amplification. The electrical output signal of the signal-processing unit 8 is finally converted by an earpiece 9 into an acoustic signal and is supplied to the hearing system of the wearer of a hearing aid by means of a sound duct 10 and a sound tube (not illustrated) connected thereto. A battery 11 supplies the electrical components of the hearing aid 1 with voltage. Furthermore, the hearing aid 1 according to the exemplary embodiment has two operator controls 12 and 13, the momentary contact switch 12 being used for selecting programs, and the volume control 13 being used to adjust the volume.

In a hearing aid 1 with a microphone system according to the exemplary embodiment it is possible to generate directional effects from the zero order to the second order. Conventionally, only the microphone signal of one microphone, for example microphone 5, has been further processed for omnidirectional reception (directional effect of the zero order). In order to generate a directional effect of the first order, two microphones conventionally have been electrically connected to one another, for example the microphones 5 and 7, and the output signal of this microphone unit was further processed. The output signal of the third microphone (in the example of the output signal of the microphone 6) was not used. The microphone 6 preferably therefore Is switched off in this mode of operation of the hearing aid 1. The output signals of all three microphones are used only to generate a directional effect of the second order. For example, for this purpose it is possible to connect the microphones 5 and 6 to form a first microphone unit with a directional effect of the first order by delaying the microphone signal which is output by the microphone 6 and subtracting it from the microphone signal which is output by the microphone 5. The microphone signal produced by the microphone 7 also can be delayed and subtracted from the microphone signal produced by the microphone 6. As a result, a second microphone unit of the first order is produced. A directional effect of the second order is obtained, for example, by delaying the microphone signal, which is output by the second microphone unit, and subtracting it from the microphone signal of the first microphone unit.

According to the invention, the three omnidirectional microphones 5, 6 and 7 are electrically connected to one another—in one of a number of possible operating modes of the hearing aid 1—to form two microphone units with a directional characteristic of the first order. Here, the first microphone unit composed of the two microphones 5 and 6, and the second microphone unit composed of the two microphones 5 and 7, preferably are formed. As is easily apparent from the drawing, the distance between the two microphones 5 and 6 (or the distance between the sound inlet openings 2 and 3 of the two microphones 5 and 6) of the first microphone unit is thus small in comparison with the distance between the two microphones 5 and 7 (or in comparison with the distance between the sound inlet openings 2 and 4 of the microphones 5 and 7) of the second microphone unit. This results in a better signal transmission behavior of the first microphone unit in the range of relatively high frequencies that can be transmitted with the hearing aid, and a better signal transmission behavior of the second microphone unit in the low frequency range. If, according to the invention, the two microphone signals of the microphone unit of the first order are not electrically connected to one another to form a directional microphone with a directional effect of the second order but rather only added, the directional microphone system which is formed in this way from the microphones 5, 6 and 7 does indeed also have only a directional characteristic of the first order but accompanied—considered over the entire frequency range which can be transmitted—by an improved signal transmission behavior In comparison with the individual microphone units which are formed from two omnidirectional microphones in each case. This advantage is not necessarily gained by increased microphone noise as would be the case if the three omnidirectional microphones 5, 6 and 7 were electrically connected to form a directional microphone system with a directional characteristic of the second order. The associated, very pronounced high pass characteristic of such a directional microphone system of the second order with the associated unaccustomed acoustic pattern is avoided by means of the invention.

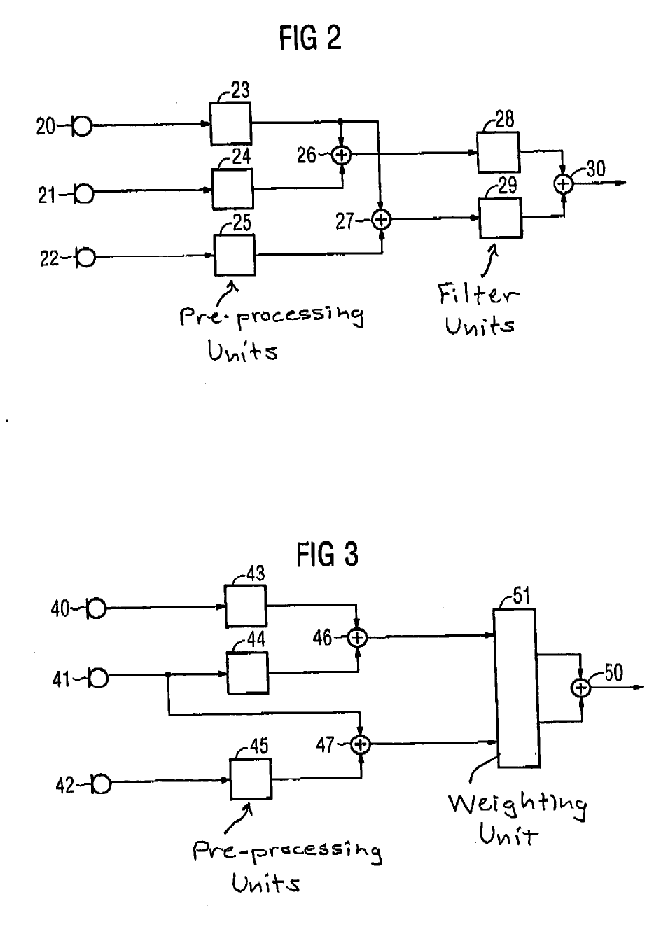

FIG. 2 shows a simplified block circuit diagram of the directional microphone system of a hearing aid with three omnidirectional microphones 20, 21 and 22 that can be arranged in a hearing aid 1, as shown, for example, in FIG. 1. In the exemplary embodiment according to FIG. 2, in each case one signal pre-processing unit 23, 24 or 26 is connected downstream of the three omnidirectional microphones 20, 21 and 22. For example A/D conversion, microphone tuning in order to compensate for component tolerances of the microphones, signal delay etc. are respectively carried out in the signal pre-processing units 23 to 25. In the exemplary embodiment, the electrical microphone signal produced by the omnidirectional microphone 21 is delayed in the signal pre-processing unit 24, inverted and added in the adder element 26 to form the electrical microphone signal produced by the omnidirectional microphone 20. As a result, the two omnidirectional microphones 20 and 21 form a first microphone unit with a directional characteristic of the first order. Likewise, the electrical microphone signal which is output by the omnidirectional microphone 22 also is delayed and inverted in the signal pre-processing unit 25 and added in an adder element 27 to form the electrical microphone signal which is output by the omnidirectional microphone 20. The two microphones 20 and 22 therefore also form a microphone unit with a directional characteristic of the first order. The inversion of microphone signal and subsequent addition to the respective other microphone signal corresponds effectively to a subtraction of the two microphone signals. In contrast to known directional microphone arrangements with three omnidirectional microphones, there is no delay and inversion of a microphone signal of the two microphone units, which would produce a directional microphone system with a directional characteristic of the second order by means of addition to the microphone signal of the respective other microphone unit. Instead, the two microphone signals produced by the microphone units with a directional characteristic of the first order are each first fed to a filter unit 28 or 29 and then added in an adder element 30. Here, the filter device 28 is in the form of a high pass filter, and the filter device 29 in the form of as a low pass filter. Since neither of the two microphone signals is delayed and inverted at the input of the adder element 30, the microphone signal that is present at the output of the adder element 30 also originates from a microphone system with a directional characteristic of the first order. This signal finally passes through the further signal processing means (not shown in the diagram) that are customary in hearing aids. When the microphones 20, 21 and 22 or the sound inlet openings of these microphones are arranged geometrically according to the exemplary embodiment in FIG. 1, the advantages which are described in the explanations relating to FIG. 1 are also obtained with the directional microphone system according to FIG. 2.

An alternative embodiment to the exemplary embodiment according to FIG. 2 is shown by FIG. 3. In this exemplary embodiment as well, three omnidirectional microphones 40, 41 and 42 are connected to one another in order to form a directional microphone system with a directional characteristic of the first order. The microphones 40, 41 end 42 also each have a signal pre-processing unit 43, 44 and 45 connected downstream of them. In contrast to the exemplary embodiment according to FIG. 2, in each case two microphones which are arranged one next to one other to form a microphone unit of the first order. As a result, the electrical microphone signal which is output by the omnidirectional microphone 41 is delayed and inverted in the signal pre-processing unit 44 and added in an adder element 46 to form the microphone signal which is output by the omnidirectional microphone 40. The two omnidirectional microphones 40 and 41 thus form a first microphone unit with a directional characteristic of the first order. The microphone signal produced by the omnidirectional microphone 42 is correspondingly also delayed and inverted in the signal pre-processing unit 45 and added in an adder element 47 to form the microphone signal that is output by the omnidirectional microphone 41. As a result, the two microphones 41 and 42 also form a microphone unit with a directional characteristic of the first order. Filter devices corresponding to the filter devices 28 and 29 according to the exemplary embodiment in FIG. 2, which are not absolutely necessary, are not provided in the exemplary embodiment according to FIG. 3. A weighting unit 51 is provided in order to weight the microphone signals differently.

If different signal delays are set in the two signal pre-processing units 44 and 45, a similar effect is thus achieved as is also produced by the different geometric distance between two microphones, forming a microphone pair, according to the exemplary embodiment in FIG. 2. This also results in a different signal transmission behavior as a function of the frequency in the microphone units when there is an identical geometric distance between the microphones 40, 41 and 42. Overall, in this exemplary embodiment there is thus also an improved signal transmission behavior—considered over the entire frequency spectrum which is transmitted by the hearing aid—in comparison to a pure two microphone arrangement, accompanied by the advantages already mentioned.

In FIG. 4, the basic advantage of the invention is illustrated graphically. The signal transmission behavior of two microphone units with a directional characteristic of the first order is illustrated as a function of the signal frequency in a diagram. Two transmission curves A and B as shown, the curve A representing the signal transmission behavior of a microphone unit with a comparatively large distance between the individual microphones and a comparatively long delay time. In contrast, curve B shows the signal transmission behavior with a small microphone distance or short delay time. Both curves have the typical high pass filter characteristic of a directional microphone system. If, according to the invention, the microphone signals of both microphone units are added, this results overall in a signal transmission behavior according to curve C, which essentially corresponds at low frequencies to the curve A and essentially corresponds at relatively high frequencies to the curve B. Overall, a good signal transmission behavior is thus obtained over a comparatively wide frequency range.

The invention is not restricted to the exemplary embodiments with a directional microphone system with three microphones in each case, but also be analogously employed in directional microphone systems with more than three microphones.

Although modifications and changes may be suggested by those skilled in the art, it is the intention of the inventor to embody within the patent warranted hereon all changes and modifications as reasonably and properly come within the scope of his contribution to the art.

1. A hearing aid comprising:
at least three microphones;
at least two of said microphones being electrically connected to form a first microphone unit having a directional characteristic of a selected order;
at least two of said microphones being electrically connected to form a second microphone unit with a directional characteristic of said selected order; and
said first and second microphone units being electrically connected to form a third microphone unit with a directional characteristic of said selected order.

2. A hearing aid as claimed in claim 1 wherein a distance between said two microphones of said first microphone unit differs from a distance between the two microphones of said second microphone unit.

3. A hearing aid as claimed In claim 1 wherein said at least three microphones comprise a first microphone, a second microphone and a third microphone, and wherein said hearing aid comprises a housing having first, second and third sound inlet openings disposed successively along a substantially straight line and respectively communicating with said first, second and third microphones, said first and second microphones being connected to form said first microphone unit, with a first order directional characteristic as said directional characteristic of a selected order, and wherein said first and third microphones are electrically connected to form said second microphone unit, with said first order directional characteristic, each of said first and second microphone units producing a microphone signal, and wherein said hearing aid comprises an adder supplied directly with said respective microphone signal of said first and second microphone units, with no relative delay or inversion of either of said microphone signals relative to the other.

4. A hearing aid as claimed in claim 1 comprising a first filter unit electrically connected downstream of said first microphone unit and having a first filter function, and a second filter unit electrically connected downstream of said second microphone unit and having a second filter function, said first and second filter functions being different.

5. A method for operating a hearing aid having at least three microphones, comprising the steps of:
electrically connecting two of said microphones to form a directional microphone unit having a directional characteristic of a selected order;
electrically connecting two of said microphones to form a second microphone unit with said directional characteristic of said selected order; and
electrically connecting said first and second microphone units to form a third microphone unit with said directional characteristic of said selected order.

6. A method as claimed in claim 5 comprising, in said first microphone unit, electrically delaying a microphone signal from one of the two microphones in said first microphone unit with respect to a microphone signal from the other of said two microphones in said first microphone unit, and subtracting the delayed microphone signal in said first microphone unit from the other microphone signal to form a microphone output signal for said first microphone unit having said directional characteristic of said selected order, and in said second microphone unit, electronically delaying a microphone signal from one of the two microphones in said second microphone unit relative to a microphone signal from the other of said two microphones in said second microphone unit, and subtracting the delayed microphone signal in said second microphone unit from the microphone signal from the other microphone in said second microphone unit, for producing a microphone output signal for said second microphone unit having said directional characteristic of said selected order.

7. A method as claimed in claim 6 comprising electronically delaying said microphone signal in said first microphone unit with a delay that is shorter than a delay used for delaying the microphone signal in said second microphone unit, and high-pass filtering a microphone signal produced by said first microphone unit and low-pass filtering a microphone signal produced by said second microphone unit.

8. A method as claimed in claim 5 wherein said first microphone unit produces a first microphone unit output signal, and wherein said second microphone unit produces a second microphone unit output signal, and comprising filtering said first microphone unit output signal with a first filter function and filtering said second microphone unit output signal with a second filter function different from said first filter function.

9. A method as claimed in claim 5 wherein said first microphone unit produces a first microphone unit output signal, and wherein said second microphone unit produces a second microphone unit output signal, and comprising weighting said first microphone unit output signal with a first weight and weighting said second microphone unit output signal with a second weight different from said first weight.

10. A method as claimed in claim 5 comprising disposing said two microphones of said first microphone unit at a distance from each other that is smaller than a distance between the two microphones of said second microphone unit, and high-pass filtering a microphone signal produced by said first microphone unit and low-pass filtering a microphone signal produced by said second microphone unit.
